(19) United States
(12) Patent Application Publication
(10) Pub. No.: US 2008/0061547 A1
(43) Pub. Date: Mar. 13, 2008

(54) Self-Stick Memo Pad

(76) Inventor: David C. T. JOUR, Taipei (TW)

Correspondence Address: Richard Chen, 7F, No. 122 Sung Chiang Rd., Taipei, omitted

(21) Appl. No.: 11/466,460

(22) Filed: Aug. 23, 2006

(51) Int. Cl. B42D 17/00

(52) U.S. Cl. 281/44

(57) ABSTRACT

The invention is related to a self-stick memo pad that can replace correction liquid (tape). In structure, it consists of one or more memo pad stacks;
each of which is composed of many pieces of self-stick memo pads, each of which has a major adhesive area at one end of the bottom and a minor non-adhesive area at the other end, so through the adhesive area, the piece sticks to the next piece of self-stick memo pad and the adhesive area end of the neighboring pieces of self-stick memo pads is arranged alternatively and they stick to each other permanently or temporarily;
a case, which is an open groove formed by curving the two sides of the base up towards the center to accommodate one or more memo pad stack, so the user can easily remove a single piece of self-stick memo pad to attach permanently or temporarily to the area to be corrected and make immediate correction. This invention therefore provides enhanced convenience in use. Further more than one memo pad stacks can be in different dimensions, depending on the user's choice, and offer multiple benefits in use.

### BACKGROUND OF THE INVENTION

1. Field of the Invention

The invention is related to a self-stick memo pad that can replace correction liquid (tape) and provide users with convenience in removing it from the memo pad stack. Especially it sticks quickly with the ease of direct writing. It is also durable and good for repeated use. The invention is sufficient to replace correction liquid or tape. The invention also provides a memo pad stack with aesthetic feeling, vision effect and added value based on multiple functions.

2. Description of the Prior Art

Correction liquid has becomes one of the most convenient and popular office or household products. It is mainly a bottle containing white and opaque correction liquid. The bottle tip is liquid outlet. When the liquid is dried, it forms a white layer. In use, the user aims the bottle tip at the writings or patterns to be corrected and squeezes the bottle to release the correction liquid to cover the desired area. When the dried layer is formed, the user can make correction in words or patterns on the layer.

Correction liquid is popular due to the convenience it provides. However, it is a little inconvenient because the liquid has to be dried before correction can be made. Its application may not get uniform coverage and is not reversible. Further, the liquid has slight toxicity; so long term inhalation may harm health. The industry has constantly improved and developed the correction tape. It has a case with correction tape inside. In use, the white and opaque correction tape comes out of the case from one end to achieve the corrective function.

Correction tape almost completely replaces correction liquid because it has many advantages, including immediate writing without the need to wait liquid drying, refillable tape, economy, easy refill, simple operation and flat correction layer etc.

Nevertheless, the inventor after long time observation and use still found the following some drawbacks for correction tapes:

1. Most correction tapes are thin, so they are easy to break or damage, and it takes more than one time to cover the area to be corrected.

2. Since when the tape is thinner, it appears more transparent. So it cannot hide dark words or patterns.

3. After correction by the tape, there is no way to go back to the original words or patterns.

In view of this, because the traditional correction liquid or tape still has some drawbacks, the inventor has improved and created a self-tick memo pad to replace correction liquid (tape).

### SUMMARY OF THE INVENTION

The main objective of the invention is to provide a simple and convenient self-stick memo pad to replace correction liquid (tape), which is made into a variety of products in different widths or lengths. It also facilitates quick correction. Its benefits also include convenience and multiple functions.

Another objective of the invention is to provide a simple and convenient self-stick memo pad to replace correction liquid (tape), which is easy to tear and stick, hard to break, able to return to original document state.

To achieve the above objectives, the self-stick memo pad for the invention consists of one or more than one memo pad stack, each of which is composed of many pieces of self-stick memo pads and can be in different or the same dimensions (width or length), and a case, which is an open groove formed by curving the two sides of the base up towards the center, to accommodate one or more than one memo pad stack.

The following embodiment with detailed description of attached figures is provided for the patent examiners to further understand the functions and features of the invention.

### BRIEF DESCRIPTION OF THE DRAWINGS

FIG. 1 is a three-dimensional structural disassembly for a preferred embodiment for the invention.

FIG. 2 is a three-dimensional structural exterior diagram for a preferred embodiment for the invention.

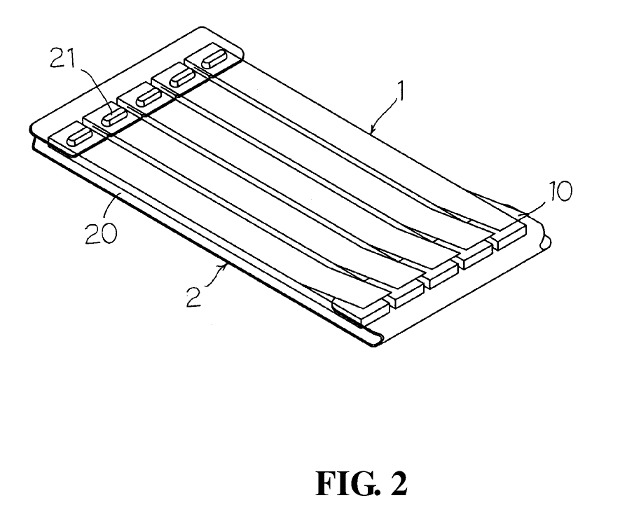

FIG. 3 is a diagram of a preferred embodiment in use for the invention.

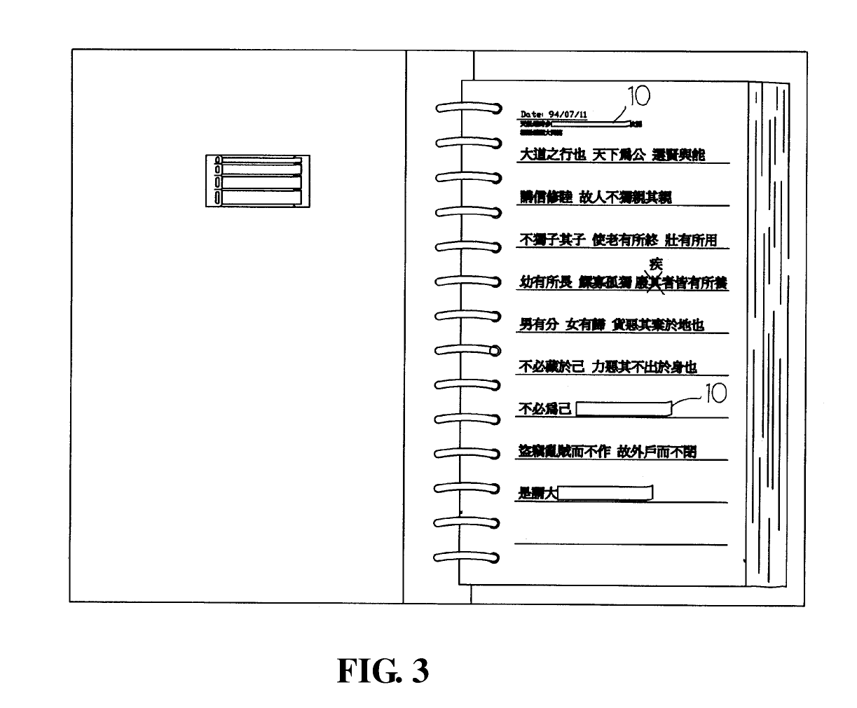

FIG. 4 a three-dimensional structural disassembly for another preferred embodiment for the invention.

FIG. 5 is a three-dimensional structural exterior diagram for another preferred embodiment for the invention.

### DETAILED DESCRIPTION OF THE PREFERRED EMBODIMENT

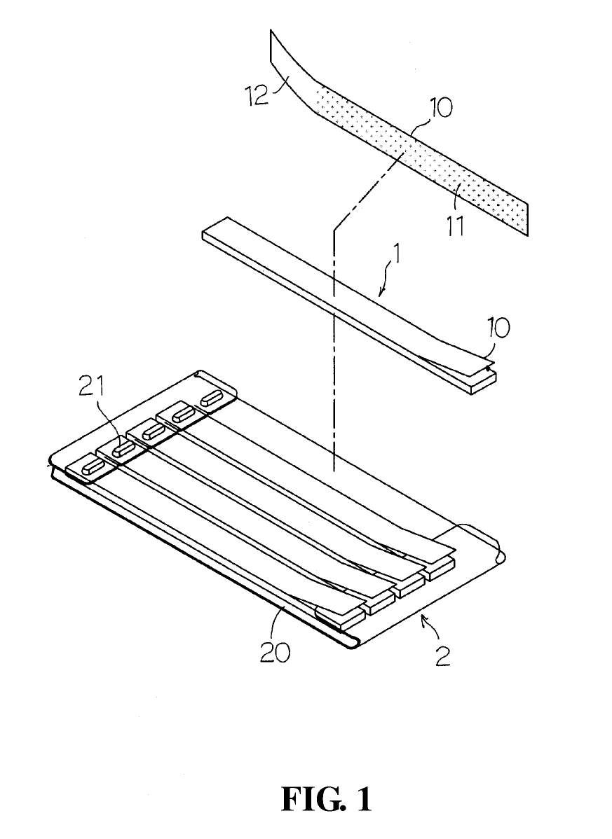

Please refer to FIG. 1. The invention is related to a self-stick memo pad to replace correction liquid (tape), which consists of a memo pad stack (1) and a case (2).

The memo pad stack (1) is composed of many pieces of self-stick memo pads (10). Each piece of self-stick memo pad (10) has a major adhesive area (11) at bottom and a minor non-adhesive area (12). Through the adhesive area (11), the piece sticks to the next piece of self-stick memo pad (10).

The case (2) is an open groove (20) formed by curving the two sides of the base up towards the center to accommodate one or more memo pad stacks (1). The larger the case (2) is, the more it accommodates memo pad stacks (1). The case (2) has several bumps (21) on both sides of the groove (20) to support the single of self-stick memo pad (10) and facilitate quick removal of the pad.

In use of the invention, the user starts removing the self-stick memo pad (10) from the non-adhesive area (12) end that is exposed on the top of the bump (21). The user then attaches the self-stick memo pad (10) on the words or patterns to be corrected, and makes direct correction afterwards. This has actually replaced the function of correction liquid and correction tape. Especially, if recovery back to the original state is desired, the user only needs to remove the self-stick memo pad (10). It is convenient and simple.

Since each neighboring piece of the self-stick memo pad (10) has adhesive area (11) end arranged alternatively on the stack, each time when one self-stick memo pad (10) is removed, the next piece of the self-stick memo pad (10) will be ready for pull-out. Besides, the non-adhesive area (12) end of this piece of self-stick memo pad (10) is exposed on the bump (21) at either side of the case (2) groove (20). This will repeat if removal of the self-stick memo pad (10) continues until the stack is out.

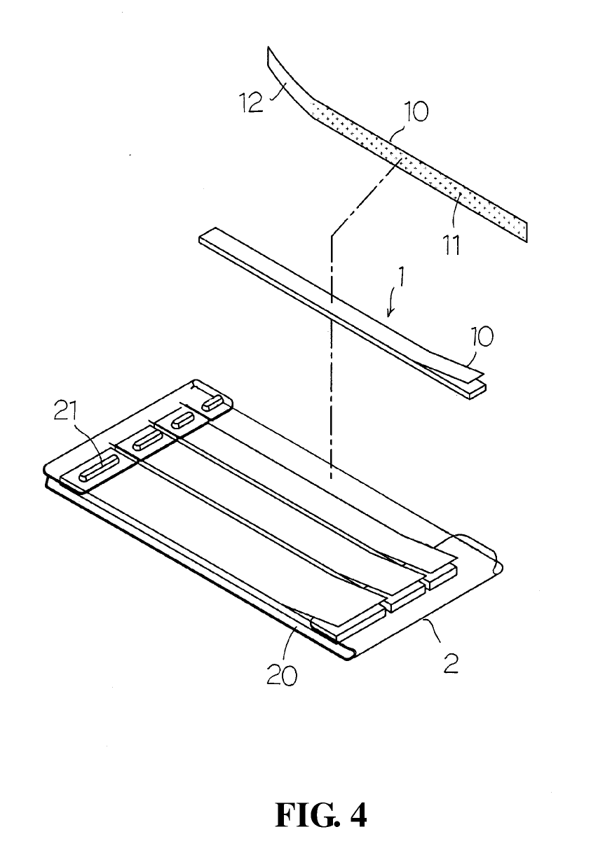

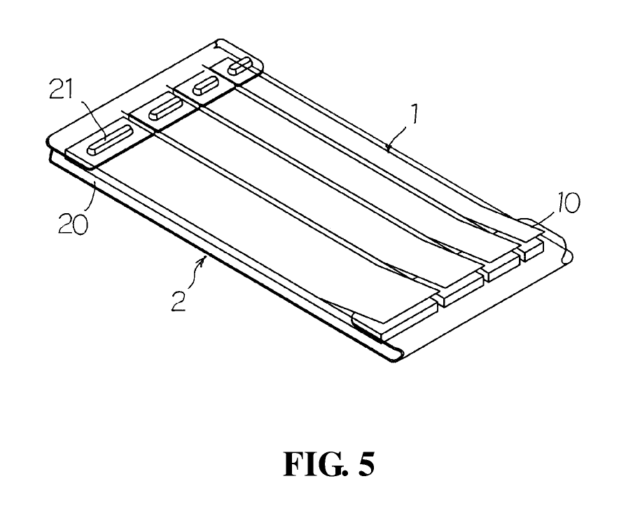

Please refer to FIG. 4 and FIG. 5. The case (2) can accommodate the memo pad stack (1) of either the same or different dimensions (width and length). It will appear like the example in the figure, which shows that the case (2) groove (20) accommodates memo pad stacks (1) in different dimensions. To facilitate the removal of the memo pad (10), depending on the quantity and dimensions of the memo pad stack (1), bumps (21) are installed at both sides of the case (2) groove (20) opening. With the support of the bump (21), the user can remove the pad even without the need to look at it. This also prevents removal of multiple pieces of self-stick memo pads (10), which is a waste.

In summary the invention is an innovative product, which has not been invented or published in the similar product category. It shall meet the patent requirements and therefore the application for a patent is thus filed.

The description above is only for a preferred embodiment for the invention. It is the intention of the inventor to declare that any equivalent modification to the principle of the invention shall be covered by the claims of the invention.

What is claimed is:

1. A self-stick memo pad to replace correction liquid consists of:
one or more memo pad stacks, each of which is composed of many pieces of self-stick memo pads in the same dimensions;
a case, which is an open groove formed by curving the two sides of the base up towards the center, to accommodate one or more memo pad stacks.

2. As described in claim 1 for a self-stick memo pad to replace correction liquid, one or more memo pad stacks can be in different dimension (width or length).

3. As described in claim 1 for a self-stick memo pad to replace correction liquid, the adhesive area end of the neighboring pieces of self-stick memo pads is arranged alternatively.
